(19) United States
(12) Patent Application Publication
(10) Pub. No.: US 2025/0053067 A1
(43) Pub. Date: Feb. 13, 2025

(54) IC CHIP, CONTROL METHOD AND GENERATION METHOD

(71) Applicant: Asahi Kasei Microdevices Corporation, Tokyo (JP)

(72) Inventors: Naoki ISOBE, Tokyo (JP); Keita OKADA, Tokyo (JP)

(21) Appl. No.: 18/638,632

(22) Filed: Apr. 17, 2024

(30) Foreign Application Priority Data
Aug. 10, 2023 (JP) 2023-130754

(51) Int. Cl. G03B 13/22; G02B 7/28

(52) U.S. Cl. CPC G03B 13/22; G02B 7/282

(57) ABSTRACT

An IC chip that controls a driving mechanism that drives an optical element based on a control signal is provided. The IC chip comprises a generation unit that generates the control signal for moving the optical element to a target position while suppressing sound generated due to the driving by the driving mechanism, based on a detection signal indicating a position of the optical element and relationship information indicating a relationship between an index corresponding to a magnitude of the sound generated due to the driving by the driving mechanism and a position of the optical element.

The contents of the following patent application(s) are incorporated herein by reference: NO. 2023-130754 filed in JP on Aug. 10, 2023.

### BACKGROUND

### 1. Technical Field

The present invention relates to an IC chip, a control method, and a generation method.

### 2. Related Art

Patent document 1 describes a motion device control circuit that stably operates a motion device regardless of a differential amount of a target value and has a short convergence time of operation when moving the motion device to a target position. Patent document 2 describes a position control apparatus that is intended to correct a driving force provided in a voice coil motor, and thereby suppress a decrease of a driving force that is generated in a region around a movable part or the like to improve follow-up performance.

### PRIOR ART DOCUMENT

### Patent Document

Patent Document 1: Japanese Patent No. 6360388
Patent Document 2: Japanese Patent No. 5259851

### BRIEF DESCRIPTION OF THE DRAWINGS

FIG. 1 shows an example of a configuration of an image-capturing apparatus 100.

FIG. 2A is an example of a block diagram indicating configurations of a generation unit 32 and a storage unit 50.

FIG. 2B is an example of a block diagram indicating configurations of the generation unit 32, the storage unit 50, and a calibration unit 36.

FIG. 3 is an example of a graph indicating a relationship between a time and a position of an optical element, and a relationship between a time and a magnitude of sound.

FIG. 4 shows an example of time dependence of the magnitude and the position of the sound on each time domain A1 to A5.

FIG. 5 is a diagram exemplifying an outline of a graph indicating frequency dependence of a magnitude of the sound generated due to the driving by a driving mechanism 20.

FIG. 6 is a flowchart indicating an example of a control method for controlling the driving of an optical element by using a driving mechanism control unit 30.

FIG. 7A is a graph indicating an example of a relationship between a position of an optical element and sound generated by the driving of the driving mechanism 20 when sound suppression control of the driving mechanism control unit 30 is not used.

FIG. 7B is a graph indicating an example of a relationship between a position of an optical element and sound generated by the driving of the driving mechanism 20 when sound suppression control of the driving mechanism control unit 30 is used.

FIG. 8A is a flowchart indicating an example of an update method for updating relationship information stored in a first storage unit 52 by using a calibration unit 36.

FIG. 8B is a flowchart describing an example of a process of step S202 in FIG. 8A.

FIG. 8C is a flowchart describing another example of a process of step S202 in FIG. 8A.

FIG. 9 is a block diagram indicating an example of a configuration of a processing unit 90 provided outside the image-capturing apparatus 100.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

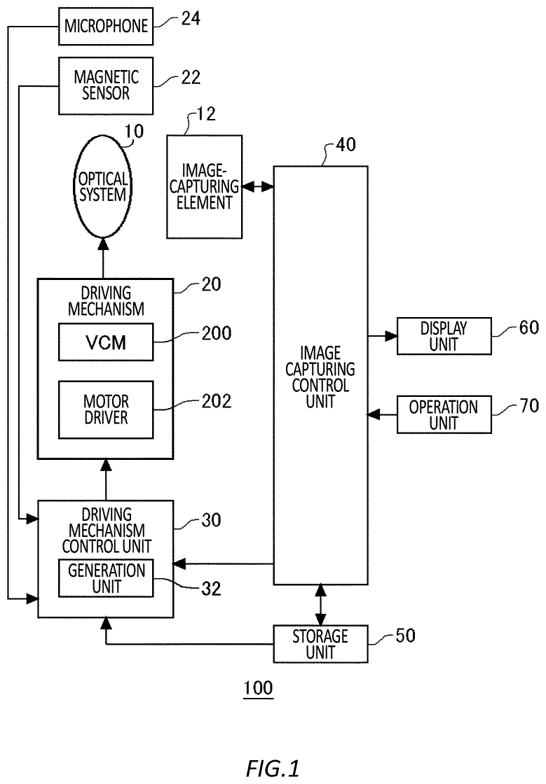

FIG. 1 shows an example of a configuration of an image-capturing apparatus 100. The image-capturing apparatus 100 is an apparatus for shooting a still image or a video of a subject by a user utilizing the image-capturing apparatus 100.

The image-capturing apparatus 100 is an apparatus including a camera that is built in a smartphone, a tablet, a laptop personal computer, a small personal computer or the like, as an example. As another example, the image-capturing apparatus 100 may be an apparatus including a camera for shooting a video such as a digital camera, a web camera, a video camera or the like. The image-capturing apparatus 100 includes an optical system 10, an image-capturing element 12, a driving mechanism 20, a magnetic sensor 22, a microphone 24, a driving mechanism control unit 30, an image-capturing control unit 40, a storage unit 50, a display unit 60, and an operation unit 70.

The optical system 10 is a composite lens system that images an image of a subject on the image-capturing element 12. The optical system 10 includes at least one of a zoom lens or a focus lens. With respect to the image-capturing apparatus 100, the optical system 10 is supported by the image-capturing apparatus 100 via a support feature. The optical system 10 of the present embodiment is driven by magnetism by the driving mechanism 20 described below. Accordingly, in this embodiment, a magnet is provided in the support feature of the optical system 10 for the image-capturing apparatus 100.

The image-capturing element 12 captures a view (an image or footage) of a subject which is imaged on an image-capturing surface of the image-capturing element 12 via the optical system 10 and outputs data of the image or the footage to the image-capturing control unit 40. Note that, a view of a still image of a subject captured by the image-capturing element 12 may be referred to as an image or a still image, and a view of a video may be referred to as a footage or a moving image in the following description. The image-capturing element 12 may be constituted by a charge coupled device (CCD) or a complementary metal oxide semiconductor (CMOS).

With respect to the image-capturing element 12, the driving mechanism 20 drives the optical system 10 or the image-capturing element 12 to change a position of the optical system 10 or the image-capturing element 12. In this manner, in the image-capturing apparatus 100, the lens position control function for focusing control, image stabilization control or the like in the image or footage captured by the image-capturing element 12 via the optical system 10 is implemented.

Here, in the present specification, the optical system 10 and the image-capturing element 12 may be collectively referred to as an “optical element”. With respect to the image or footage captured by the optical element, when an image stabilization correction function or the like is implemented in the image-capturing apparatus 100, the driving mechanism 20 may also drive the image-capturing element 12 instead of the optical system 10 or in addition to the optical system 10. In the figure, for the brevity of description, an example in which a driving target of the driving mechanism 20 is the optical system 10 is indicated, but the driving target of the driving mechanism 20 is not limited thereto, and the present embodiment includes a case in which the driving mechanism 20 drives either of the optical system 10 or the image-capturing element 12, or both of them.

The driving mechanism 20 of the present embodiment varies a position and an angle (the position and the angle may be collectively referred to as “position” in the following description) of the optical system 10 or the image-capturing element 12 by driving the optical system 10 or the image-capturing element 12. When a three-dimensional space is represented with an XYZ space, the driving mechanism 20 may vary a position in one direction within the XYZ space of the optical system 10 or the image-capturing element 12, or may vary positions in a plurality of directions.

For example, the driving mechanism 20 drives the optical system 10 or the image-capturing element 12 along an optical axis direction of a lens of the optical system 10 in order to implement a focusing control such as autofocus function or the like of the image-capturing apparatus 100. That is, the driving mechanism 20 drives the optical element along an optical axis of the optical element. Note that, the optical axis of the lens means an axis that connects a center point of the lens to a focus position of the lens. In addition, “a direction along the optical axis direction of the lens” may mean, for example, a direction in which each of an angle between an X axis and a Y axis and an angle between a Z axis and the X axis is within a range of ±3 degrees or less, with respect to the optical axis direction (a direction parallel to the optical axis direction is referred to as an X axis direction). Note that, “the direction along the optical axis direction of the lens” may be defined to be a direction in which each of an angle between the X axis and the Y axis and an angle between the Z axis and the X axis is within a range of ±1 degree or less, or each of an angle between the X axis and the Y axis and an angle between the Z axis and the X axis is within a range of ±0.5 degree or less, according to a correction function that is desired to be implemented for the image-capturing apparatus 100.

Alternatively, the driving mechanism 20 varies the position and the angle of the optical system 10 or the image-capturing element 12 to implement an image stabilization function of the image-capturing apparatus 100. To quickly follow a blur such as a camera shake or the like, when the image-capturing element 12 is lighter than the optical system 10, the driving mechanism 20 may drive the image-capturing element 12 or drive both the optical system 10 and the image-capturing element 12.

The driving mechanism 20 in the present embodiment is an electromagnetic actuator that drives an optical element by an electromagnetic interaction by varying a magnetic field around the optical element. The driving mechanism 20 includes a voice coil motor 200 and a motor driver 202. Note that the driving mechanism 20 is not limited to the electromagnetic actuator, but may be a shape memory alloy (SMA) actuator, piezo (piezoelectric) actuator, or the like.

The magnetic sensor 22 detects the position of the optical system 10 or the image-capturing element 12, and outputs a detection signal indicating the position of the optical system 10 or the image-capturing element 12. The magnetic sensor 22 is a magnetic sensor using a magnetic sensor element such as, for example, a hall element, a TMR element using a tunnel magnetoresistive effect, a GMR element using a giant magnetoresistance, or the like. The magnetic sensor 22 may include one or more magnetic sensor elements according to a desired detection range and detection accuracy upon the detection of the position of the optical system 10 or the image-capturing element 12. For example, the magnetic sensor 22 may include a plurality of hall elements. When the driving mechanism 20 is an electromagnetic actuator, the magnetic sensor 22 can be used to measure the position precisely.

When the position is detected by the magnetic sensor 22, the magnetic sensor 22 may be provided at a position where a magnetic field that is varied by the driving mechanism 20 around a magnet of the optical element is easy to detect. The magnetic sensor 22 is provided on an axis passing through a geometric center of a winding of a coil in the voice coil motor 200, as an example. Note that the magnetic sensor 22 may be provided anywhere in the image-capturing apparatus 100 provided that the position of the optical system 10 or the image-capturing element 12 can be detected.

The image-capturing apparatus 100 may include another sensor such as an inertial measurement unit (IMU) or the like as a configuration for performing a position detection of the optical element, instead of the magnetic sensor 22 or in addition to the magnetic sensor 22. The detection signal may be a signal corresponding to position information of the optical system 10 or the image-capturing element 12 that is output by a composite sensor thereof.

The microphone 24 detects sound data corresponding to sound generated due to the driving by the driving mechanism 20. The microphone 24 outputs a current or voltage corresponding to the sound data to the driving mechanism control unit 30. The microphone 24 may be a microphone that can be also used as a microphone for recording audio upon a video shooting of the image-capturing apparatus 100.

The driving mechanism control unit 30 outputs a control signal that controls a supply of a voltage, current or the like supplied to the voice coil motor 200 such that the driving mechanism 20 drives the optical element. Specifically, the driving mechanism control unit 30 outputs a control signal for driving the optical element so as to move the optical element to a target position based on a target position command signal from the image-capturing control unit 40 and the detection signal from the magnetic sensor 22, and to suppress a sound generated due to the driving by the driving mechanism 20.

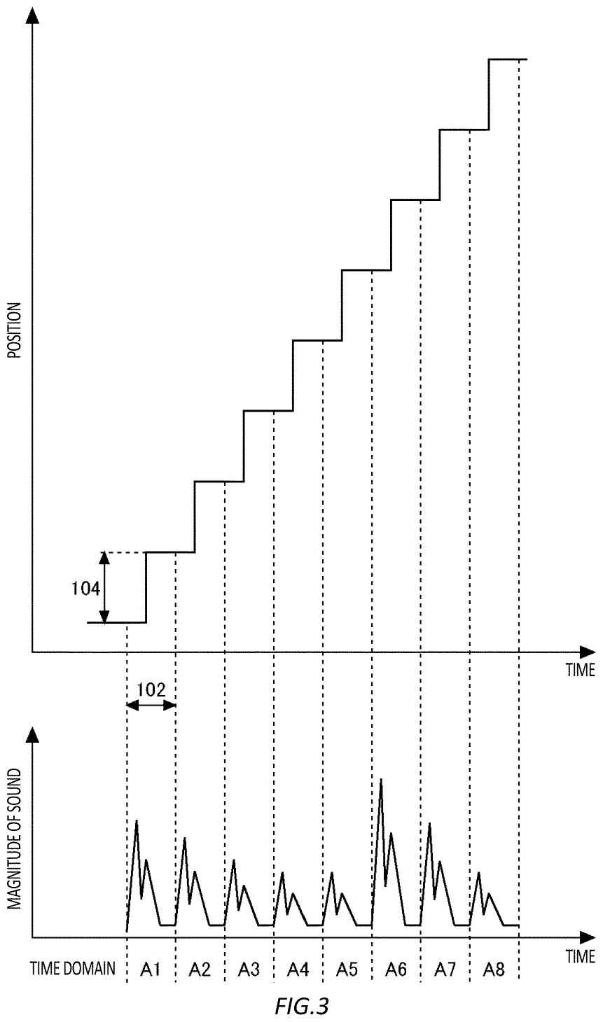

The driving mechanism control unit 30 may control such that the optical element is gradually moved by a step width for each update cycle of the control signal and will be eventually moved to the target position. Accordingly, the update cycle of the control signal indicates a cycle by which the target position indicated in the control signal is updated. That is, the update cycle of the control signal indicates a period in which the target position indicated in the control signal is fixed to a predetermined value. In addition, the step width of the control signal is a constant movement amount (distance) by which the optical element moves for one operation among a plurality of steps in which the driving mechanism control unit 30 varies, when driving the optical element from current position, the position within the update cycle so as to be eventually moved to the target position. The update cycle and step width are described below with a specific example (an update cycle 102 and a step width 104) referring to FIG. 3.

Here, the driving mechanism control unit 30 may be integrated into the same IC chip as that of the magnetic sensor 22, and the driving mechanism control unit 30 is an example of “a control apparatus”. That is, the image-capturing apparatus 100 may include an IC chip, and the IC chip may include a magnetic sensor 22. In addition, the IC chip may include the driving mechanism control unit 30. The driving mechanism control unit 30 includes a generation unit 32. The generation unit 32 generates a control signal for moving the optical element to the target position and outputs the control signal to the motor driver 202. The motor driver 202 supplies the voltage or current corresponding to the control signal to the voice coil motor 200. The voice coil motor 200 is driven according to the voltage or current from the motor driver 202 to move the optical element.

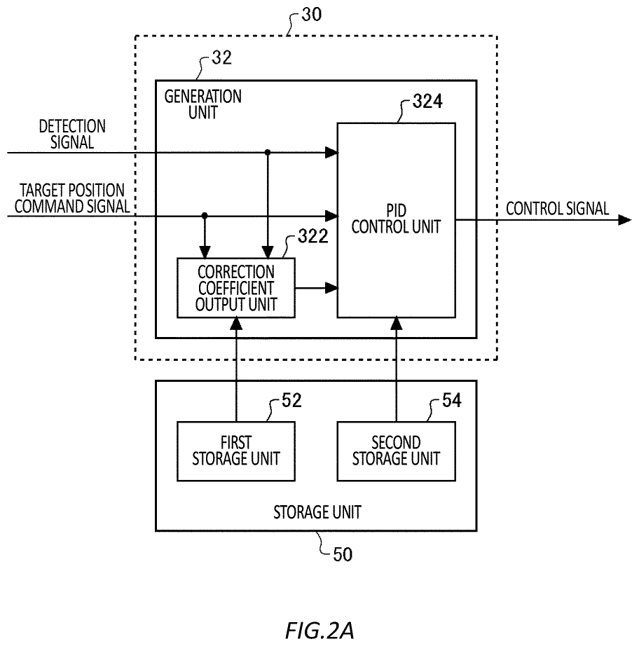

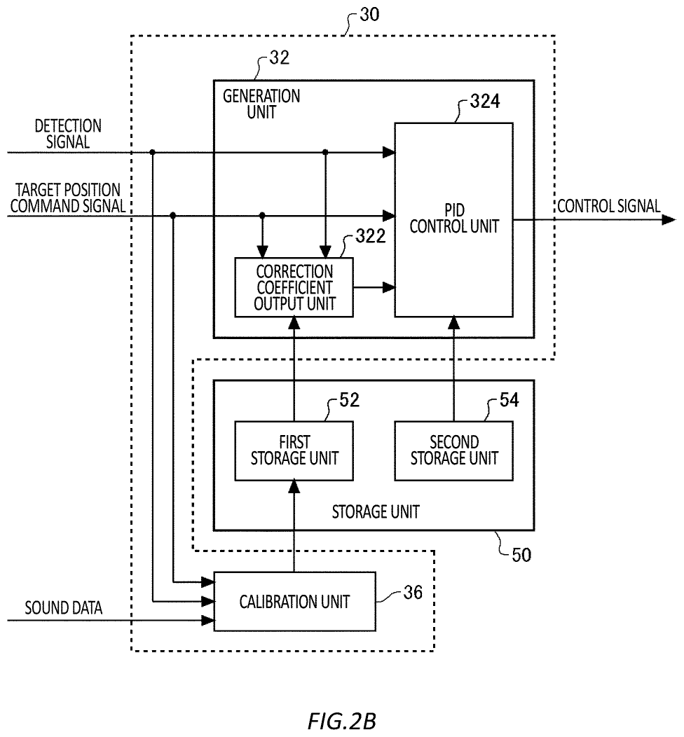

In the present embodiment, the generation unit 32 generates a control signal for moving the optical element to the target position while suppressing sound generated due to the driving by the driving mechanism 20. The generation unit 32 acquires a detection signal indicating the position of the optical element via the magnetic sensor 22. Furthermore, as described below referring to FIG. 2A, the generation unit 32 generates a control signal for moving the optical element to the target position while suppressing the sound generated due to the driving by the driving mechanism 20, based on position information of an optical element that is read from the target position signal and the detection signal from the magnetic sensor 22 and relationship information indicating a relationship between an index corresponding to the magnitude of the sound generated due to the driving by the driving mechanism 20 and the position of the optical element.

In particular, the generation unit 32 performs proportional integral differential (PID) control upon moving the optical element to the target position, as described below referring to the PID control unit 324 in FIG. 2A. Accordingly, the generation unit 32 generates the control signal based on a PID parameter, which has a proportional component, an integral component, and a differential component of a deviation between the target position and a current position acquired from the detection signal, as an element. The generation unit 32 generates a control signal with those PID parameters being corrected upon suppressing the sound corresponding to the position of the optical element.

In addition, the sound generated due to the driving by the driving mechanism 20 may depend on a speed and acceleration when the optical element moves. The generation unit 32 can generate a control signal for suppressing the sound generated due to the driving by the driving mechanism 20, by suppressing the speed or acceleration when the optical element moves.

The image-capturing control unit 40 outputs the target position signal indicating the target position of the optical element. The image-capturing control unit 40 sets the target position of the optical element based on at least one of an operation of a user that is input from the operation unit 70, a contrast of the image or footage that is captured by the image-capturing element, a phase difference data that is detected by an autofocus sensor provided together with the image-capturing element, or the like, and outputs the target position signal.

The storage unit 50 stores information which is for controlling the position of the optical system 10 or the image-capturing element 12 by the driving mechanism control unit 30 and the image-capturing control unit 40. The storage unit 50 may have a memory for storing information for controlling by the driving mechanism control unit 30 and a memory for storing information for controlling by the image-capturing control unit 40. The storage unit 50 may have one memory for storing information for controlling by both the driving mechanism control unit 30 and the image-capturing control unit 40.

The display unit 60 displays the image or footage of the subject that is captured by the image-capturing apparatus 100 to a user. The user can perform various operations using the operation unit 70 described below based on the image or footage displayed by the display unit 60.

The operation unit 70 is an interface for operating the image-capturing apparatus 100 by a user of the image-capturing apparatus 100. The user can perform various operations on the image or footage found through the display unit 60 by using the operation unit 70. Via the operation unit 70, the user can select a focusing target, switch between a video shooting mode and a still image shooting mode, or set a timing for starting storing a video in the storage unit 50 or a timing for ending the storing, for example.

Here, the driving mechanism control unit 30 has operating modes of a correction mode and a non-correction mode. “The correction mode” is a mode that performs, upon the drive by the driving mechanism 20 to the target position, a control based on the control signal that is corrected to suppress the sound corresponding to the position of the optical system 10 or the image-capturing element 12. On the other hand, “the non-correction mode” is a mode that does not perform, upon the drive by the driving mechanism 20 to the target position, a correction of the control signal for suppressing the sound corresponding to the position.

The driving mechanism control unit 30 may perform a switching of the operating modes between the correction mode and the non-correction mode as described below. Furthermore, the user can switch the operating modes of the driving mechanism control unit 30 between the correction mode and the non-correction mode via the operation unit 70.

The sound may not be recorded in the shot data even if the sound is generated when the user shoots a still image, and thus when a variation of the positions of the focusing target subject upon a video shooting is small or the driving mechanism 20 only performs a driving with electrical power of a predetermined threshold or less, or the like. In such a case, the driving mechanism control unit 30 may operate under the non-correction mode in which a correction of the control signal for sound suppression in the present embodiment is not performed.

In the correction mode under which the sound suppression is performed, a movement speed of the optical element at a position in which a loud sound may be generated is reduced. Accordingly, when the sound described above is not a problem, the user can consciously switch between the correction mode and the non-correction mode via the operation unit 70.

Specifically, the user of the image-capturing apparatus 100 transmits an instruction for switching between the correction mode and the non-correction mode to the driving mechanism control unit 30 through the operation unit 70. In this embodiment, the image-capturing control unit 40 receives the instruction for switching between the correction mode and the non-correction mode via the operation unit 70 from the user. The image-capturing control unit 40 transmits the instruction for switching between the correction mode and the non-correction mode to the driving mechanism control unit 30. The driving mechanism control unit 30 switches between the correction mode and the non-correction mode according to the instruction upon receiving the instruction for switch between the correction mode and the non-correction mode. Note that the switching between the correction mode and the non-correction mode may be directly input into the driving mechanism control unit 30 from the operation unit 70.

The following describes an example in which the driving mechanism control unit 30 switches between the correction mode and the non-correction mode. The user of the image-capturing apparatus 100 switches, via the operation unit 70, between a moving image capturing mode and a still image capturing mode for the image that is to be captured. In this case, the driving mechanism control unit 30 may receive a notification from the image-capturing control unit 40 indicating that the switching between the moving image capturing mode and the still image capturing mode has been performed, and switch between the correction mode and the non-correction mode according to the notification, and the driving mechanism control unit 30 may operate under the correction mode during the moving image capturing mode and operate under the non-correction mode during the still image capturing mode.

As another example, when the position of the focusing target described above does not vary for a long time, and a blur or the like is not detected due to the image-capturing apparatus 100 being fixed to a fixing instrument such as a tripod or the like, the driving mechanism control unit 30 may operate under the non-correction mode. In addition, the driving mechanism control unit 30 may switch between the operating modes so as to operate under the correction mode in response to a motion and an image blur of the focusing target being detected by the image-capturing control unit 40.

For yet another example, when the image-capturing apparatus 100 has a switch or the like for turning on or turning off an OIS (optical image stabilization) mode, it is predicted that a position of the optical element will be controlled with a high speed in the OIS. Accordingly, the driving mechanism control unit 30 may switch from the non-correction mode to the correction mode in response to the image-capturing control unit 40 turning on the OIS mode. The driving mechanism control unit 30 may switch from the correction mode to the non-correction mode in response to the detection of the image-capturing control unit 40 turning off the OIS mode or the image-capturing apparatus 100 being installed on a tripod or the like, and so forth.

In the image-capturing apparatus 100, the display unit 60 and the operation unit 70 may be integrally provided as a touch screen. Note that the operation unit 70 may be provided as an element that is different from the display unit 60, such as an operation button of a camera.

The following describes a configuration included in the driving mechanism 20. The voice coil motor 200 varies, by an electromagnetic induction, a magnetic field around a magnet provided together with the optical element, and drives the optical system 10 or the image-capturing element 12 by electromagnetic force generated in response to the variation of the magnetic field.

The driving force of the voice coil motor 200 is proportional to the magnitude of current flowing in the coil of the voice coil motor 200. Accordingly, the sound generated due to the driving by the driving mechanism 20 corresponding to the driving of the optical element is easily increased as the driving force is increased.

Furthermore, the sound generated by the driving mechanism 20 upon the driving of the optical element is easily increased as a rate of change of the current flowing in the voice coil motor 200 becomes steep. When the rate of change of the current becomes steep, a force that is close to impulsive force for at least a part of a component in the driving mechanism 20, particularly a part included in a voice coil motor 200 may be generated due to a rapid current change, for example. With respect to such force, stress may be generated on the part or structure of the driving mechanism 20, and a vibration may be generated in the driving mechanism 20. Accordingly, the vibration in the driving mechanism 20 may increase the sound generated due to the driving by the driving mechanism 20.

In particular, when the vibration in the example described above is generated, the frequency of the vibration may be a frequency that is close to a resonant frequency in the part or structure of the driving mechanism 20. When the vibration of the frequency that is close to the resonant frequency is generated, the vibration in the driving mechanism 20 may increase the sound generated due to the driving by the driving mechanism 20.

As another example, when the rate of change of the current becomes steep, the speed or motion of the optical element may be changed due to the current that is rapidly flowing, and contact or frictional force of at least a part of the part of the driving mechanism 20, particularly a part such as a rotating body or the like having the voice coil motor 200 may vary. The variation of such contact or frictional force may increase the sound generated due to the driving by the driving mechanism 20.

The generation unit 32 can generate a control signal for suppressing at least one of the voltage, the rate of change of the current, or a magnitude of the current supplied to the voice coil motor 200 in order to suppress the sound generated due to the driving by the driving mechanism 20.

The motor driver 202 adjusts a magnetic field which is varied by the voice coil motor 200, by adjusting at least one of the voltage, the rate of change of the current, or the magnitude of the current supplied to the voice coil motor 200, based on the control signal output by the driving mechanism control unit 30. In this manner, the motor driver 202 applies the driving force on the optical element. Accordingly, the driving mechanism 20 drives the optical element by the driving force from the voice coil motor 200 based on the control signal.

In the image-capturing apparatus 100 of the present embodiment, if the driving mechanism control unit 30 is integrated into the same IC chip as that of the magnetic sensor 22, the signal processing of the driving mechanism control unit 30 may be performed as a digital processing. In such a case, the driving mechanism control unit 30 may include an ADC (Analog to Digital Converter) for converting a detection signal that is from the magnetic sensor 22 to a digital signal. On the other hand, the driving mechanism 20 may include a DAC (Digital to Analog Converter) for converting a control signal provided from the driving mechanism control unit 30 into an analog signal and providing it to the motor driver 202.

In this manner, each component of the image-capturing apparatus 100 may include the ADC or DAC for appropriate digital processing or analog processing on the signal. Illustration of such an ADC or DAC is omitted in each diagram for the brevity of description.

Here, when the driving mechanism 20 drives the optical element, sound due to the driving may be generated in at least one of the optical element and a support feature thereof or the driving mechanism 20. When the user shoots a video of a subject by the image-capturing apparatus 100, audio at the time of the shooting is recorded together with a footage of the subject. For a good user experience of the user watching the captured video, it is preferable that the sound is smaller relative to the audio to be recorded.

The sound due to the driving by the optical element performed by the driving mechanism 20 is generated due to an effect of frictional force or the like during the movement of the optical element. A value of the frictional force during the movement of the optical element may fluctuate depending on the position of the optical system 10 or the image-capturing element 12. Here, as a reason for the fluctuation of the value of dynamic frictional force, for example, a coating amount of grease coated on the optical element or the support feature may vary and the dynamic friction coefficient may vary within a driving range of the optical element depending on the position of the optical element.

Accordingly, the sound generated due to the driving by the optical element by the driving mechanism 20 is the sound corresponding to the position of the optical system 10 or the image-capturing element 12. Such a sound increases, in particular, when the speed of the optical system 10 or the image-capturing element 12 is high. In the image-capturing apparatus 100, when the dependence of the sound on the position of the optical element is not evaluated but a drive control for uniformly reducing the sound is performed, the entire drive control performed by the driving mechanism 20 may restrict the driving speed.

The generation unit 32 may generate a control signal for moving the optical element to the target position while suppressing the sound corresponding to the position of the optical element based on a relationship between the sounds due to the driving corresponding to the position of the optical element read from the detection signal and the position that is acquired from the microphone 24. Hereinafter, the internal configuration and operation of the generation unit 32 will be described in detail referring to FIG. 2A.

FIG. 2A is an example of a block diagram indicating configurations of a generation unit 32 and a storage unit 50. The generation unit 32 includes a correction coefficient output unit 322 and a PID control unit 324. In addition, the storage unit 50 includes a first storage unit 52 and a second storage unit 54.

The generation unit 32 generates a control signal based on a detection signal indicating the position of the optical element, a correction coefficient corresponding to the magnitude of the sound generated due to the driving by the driving mechanism, and relationship information indicating the relationship between the position of the optical element read from sound data corresponding to the position of the optical element and an optimal correction coefficient. The relationship information is information indicating, as an index corresponding to the magnitude of the sound generated due to the driving by the driving mechanism 20, a correction coefficient corresponding to the position of the optical element for correcting the control signal according to the magnitude of the sound generated due to the driving by the driving mechanism 20.

The correction coefficient output unit 322 calculates the correction coefficient for the PID parameter and outputs the calculated correction coefficient. Specifically, the correction coefficient output unit 322 of the present embodiment calculates the correction coefficient based on the current position of the optical element read from the detection signal and the relationship information read from the first storage unit 52 and outputs the calculated correction coefficient to the PID control unit 324.

Upon calculating the correction coefficient, the correction coefficient output unit 322 of the present embodiment detects the current position of the optical element based on the detection signal that is acquired based on the position detected by the magnetic sensor 22. Note that the correction coefficient output unit 322 may identify the position of the optical element based on the target position indicated in the target position signal. The position detection from the target position signal has an advantage in that the target position signal also has a high noise tolerance.

That is, when the generation unit 32 identifies the correction coefficient, the generation unit 32 may identify the position of the optical element based on at least one of the detection signal or the target position signal. In this case, the generation unit 32 can identify the correction coefficient corresponding to the position of the identified optical element by referring to the relationship information stored in the first storage unit 52. Accordingly, the generation unit 32 may generate the control signal based on the correction coefficient corresponding to the position of the optical element, the target position signal indicating the target position, and the detection signal.

The PID control unit 324 performs an arithmetic operation for calculating a reference PID parameter based on the deviation between the current position and the target position and stores the calculated reference PID parameter in the second storage unit 54. The PID control unit 324 calculates a PID parameter obtained by reflecting a correction by the correction coefficient to the calculated reference PID parameter.

The reference PID parameter is a PID parameter in a case where a correction by the correction coefficient is not performed in the PID control unit 324. The image-capturing apparatus 100 can generate the control signal by using the reference PID parameter under the non-correction mode.

Specifically, the PID control unit 324 calculates the PID parameter for each of the proportional component, the integral component, and the differential component based on the deviation between the current position of the optical element acquired from the detection signal and the target position acquired from the target position signal. The PID control unit 324 further adds or subtracts the proportional component, the integral component, and the differential component by an adder.

The correction coefficient calculated by the correction coefficient output unit 322 may be a coefficient that corrects at least one of the proportional component, the integral component, or the differential component before the adder performs the adding or subtracting thereto, or may be a coefficient that corrects an adding or subtracting result of the proportional component, the integral component, or the differential component. Accordingly, the generation unit 32 can correct the PID parameter by performing four arithmetic operations using the correction coefficient corresponding to the position of the optical element on at least one of the proportional component, the differential component, and the integral component based on the deviation between the target position signal and the detection signal.

The PID control unit 324 further outputs a control signal for controlling by which the optical element is moved such that the position of the optical element reaches from the current position acquired from the detection signal to the target position read from the target position signal. The generation unit 32 generates the control signal based on the PID parameter obtained by correcting in such a manner, and the driving mechanism control unit 30 may output the generated control signal.

In this manner, the generation unit 32 can generate the control signal for performing a PID control on the driving mechanism 20 based on the correction coefficient corresponding to the position of the optical element, the target position signal, and the detection signal. Accordingly, the generation unit 32 generates the control signal based on the correction coefficient corresponding to the position of the optical element, the target position signal indicating the target position, and the detection signal.

For the control of the driving mechanism control unit 30 depending on the position of the optical element, which is for suppressing the sound obtained due to the driving by the driving mechanism 20, there are several achieving means. Hereinafter, some of the several achieving means will be illustrated.

For example, in order to suppress the sound corresponding to the position of the optical element upon the driving mechanism 20 drives the optical element, the generation unit 32 may adjust the control signal such that the deviation between the current position that is input for correcting the PID parameter and the target position decreases, that is, such that a provisional target position for setting the target position at a position close to the current position is set. For example, the generation unit 32 may embody this by adjusting the value of the control signal and setting the provisional target position such that the deviation between the target position and the current position decreases.

In this manner, the generation unit 32 may set the provisional target position such that the deviation between the position of the optical element and the target position decreases in the control signal, and may perform a control for moving the provisional target position asymptotically to an original target position in the target position signal. By setting the deviation between the current position and the provisional target position smaller than the deviation between the current position and the original target position, the speed of the optical system 10 or the image-capturing element 12 decreases, and as a result, the sound obtained due to the driving by the driving mechanism 20 is reduced.

As another example, the driving mechanism control unit 30 may limit, by the control signal, the operation amount of the speed, acceleration or the like for the driving mechanism 20 to operate the optical element to the target position. For example, the driving mechanism control unit 30 may provide a predetermined threshold for the operation amount depending on the position, and limit the operation amount to be equal to or less than the threshold. Alternatively, the driving mechanism control unit 30 may limit the operation amount to be a constant value within a predetermined driving range of the driving mechanism 20.

In this manner, the generation unit 32 may generate a control signal obtained by correcting by a correction coefficient so as to adjust a gain of a drive band of the driving mechanism 20. In particular, the generation unit 32 may generate the control signal for correcting the gain of the drive band of the driving mechanism 20 with a four arithmetic operation that uses the correction coefficient corresponding to the position of the optical element.

For yet another example, the generation unit 32 can reduce, by changing the frequency for changing the value indicating the control signal according to the position of the optical element, the sound generated due to the driving by the driving mechanism 20. Specifically, the driving mechanism control unit 30 reduces the update frequency of the control signal to be output within a range in which the sound generated due to the driving by the driving mechanism 20 is increased. The control signal indicates the same value due to the control signal being not updated, and then the current supplied to the voice coil motor 200 becomes constant and the inclination of the current decreases. In this manner, the sound obtained due to the driving by the driving mechanism 20 can be reduced within a range in which the update frequency of the control signal is reduced.

As already mentioned, the image-capturing apparatus 100 of the present embodiment is provided with the ADC and DAC as required. In particular, when a digital signal is input from the driving mechanism control unit 30 to the driving mechanism 20 and a signal that is converted by the DAC is input to the motor driver 202, the control for reducing the update frequency of the control signal is achieved by reducing the update frequency of this DAC.

That is, in order to suppress the sound generated due to the driving by the driving mechanism 20, the driving mechanism control unit 30 may control, within the range in which the sound generated due to the driving by the driving mechanism 20 increases, the DAC so as to increase the update cycle 102 of the DAC for controlling the input to the driving mechanism 20. In this manner, the driving mechanism control unit 30 can mitigate the frequency of updating the magnitude of the current supplied to the voice coil motor 200, and the variation of the driving force. As a result, the driving mechanism control unit 30 can suppress the sound obtained due to the driving by the driving mechanism 20.

For yet another example, in order to suppress, according to the position of the optical element, the sound generated due to the driving by the driving mechanism 20 within the range in which the sound generated due to the driving by the driving mechanism 20 increases, the motor driver 202 may adjust a power supply or the like so as to reduce the height of the power voltage supplied to the driving mechanism 20. For example, the driving mechanism control unit 30 may reduce, according to the position of the optical element, the level of voltage supplied to the motor driver 202 via a level shifter within the range in which the sound generated due to the driving by the driving mechanism 20 increases. The motor driver 202 may adjust so as to reduce an absolute value of the current supplied to the voice coil motor 200, the magnitude of an inclination of the current, or acceleration of current, instead of controlling the power voltage or in addition to controlling the power voltage. In this manner, the driving mechanism control unit 30 can control, by the control signal that is output, the absolute value of the current supplied to the voice coil motor 200 and the magnitude of the rate of change of the current.

In addition, in order to suppress, by the control signal, the sound generated due to the driving by the driving mechanism 20, the driving mechanism control unit 30 may reduce a duty ratio of the current (corresponding to a density of the pulse wave supplied by a PWM (Pulse Width Modulation) control) supplied to the voice coil motor 200 from the motor driver 202 by the PWM control or the like. In this manner, the driving mechanism control unit 30 can control the driving mechanism 20 such that the density of pulse wave supplied to the voice coil motor 200 is reduced and the electrical power supplied to the voice coil motor 200 decreases within the range in which the sound generated due to the driving by the driving mechanism 20 increases. In this manner, the driving mechanism control unit 30 can suppress the sound generated due to the driving by the driving mechanism 20.

For yet another example, the driving mechanism 20 may include, as a motor driver 202, a plurality of motor drivers 202 whose electrical power output to the voice coil motor 200 is different. In order to suppress the sound generated due to the driving by the driving mechanism 20, the driving mechanism control unit 30 selects, according to the position of the optical element, a motor driver 202 which can supply the electrical power that can suppress the sound generated due to the driving by the driving mechanism 20 to have a predetermined magnitude or less to the voice coil motor 200, among the plurality of motor drivers 202.

For example, the storage unit 50 stores a predetermined correspondence table, which indicates the a motor driver 202 which supplies voltage, current, or electrical power to the voice coil motor 200 for each range of the voltage, the current, or the electrical power supplied to the voice coil motor 200. The driving mechanism control unit 30 selects a motor driver 202 which supplies the voltage, the current, or the electrical power among the plurality of motor drivers 202 based on a desired voltage, current, or electrical power and the correspondence table, and outputs the control signal to the selected motor driver 202. The selected motor driver 202 supplies the voltage, the current, or the electrical power to the voice coil motor 200 based on the control signal. In this manner, the driving mechanism control unit 30 can suppress, according to the position of the optical element, the sound generated due to the driving by the driving mechanism 20.

The above describes several examples of control in which a reduction of the sound generated due to the driving by the driving mechanism 20 achieved by the driving mechanism 20, the driving mechanism control unit 30, the image-capturing control unit 40 or the like according to the position of the optical element. These controls may include, according to the position of the optical system 10 or the image-capturing element 12, a control of the speed or acceleration of the optical system 10 or the image-capturing element 12, an inclination (a rate of change of the current) of current flowing in the voice coil motor 200, an acceleration of current or the like, unlike a case in which simply controlling the driving force without the purpose of suppressing the sound generated due to the driving.

By performing those controls, a sound corresponding to the position of the optical system 10 or the image-capturing element 12 that is generated due to the driving by the driving mechanism 20 is suppressed and a reduction amount of the speed of the optical system 10 or the image-capturing element 12 decreases compared to a case in which a control according to a position is not performed. Accordingly, both high speed and quietness are achieved in the control due to the driving of the driving mechanism 20 such as an image stabilization control, a focusing control, or the like of the image-capturing apparatus 100.

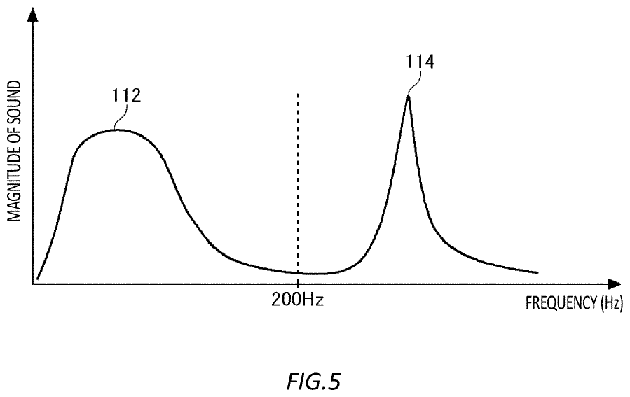

As already described, the first storage unit 52 stores the relationship information. An IC chip having the driving mechanism control unit 30 may include a first storage unit 52. In addition, as described below referring to FIG. 5, the first storage unit 52 may store data of correspondence between the magnitude of the sound generated by the driving mechanism 20 upon the driving of the optical element and a correction coefficient defined for the magnitude of the generated sound. The second storage unit 54 stores a reference PID parameter.

FIG. 2B is an example of a block diagram indicating configurations of the generation unit 32, the storage unit 50, and a calibration unit 36. Compared to the embodiment of FIG. 2A, in the embodiment of FIG. 2B, the driving mechanism control unit 30 includes a calibration unit 36. Accordingly, the following describes the calibration unit 36 which is a difference between FIG. 2B and FIG. 2A in detail and the descriptions already mentioned in FIG. 2A are omitted in the following description.

In this embodiment, the calibration unit 36 is provided within the driving mechanism control unit 30 and separate from the generation unit 32. Note that the calibration unit 36 may be provided in the generation unit 32.

Here, for example, a sound at a specific position of the optical element may be increased upon the drive of the driving mechanism 20 due to the aging of support features of the optical element. In such a case, the calibration unit 36 is provided for calibrating the relationship information stored in the first storage unit 52. The calibration unit 36 generates the relationship information based on sound information indicating a magnitude of the sound corresponding to the position of the optical element generated due to the driving by the driving mechanism 20 according to a predetermined driving condition and correction coefficient information indicating a relationship between the magnitude of the sound and the correction coefficient and stores the relationship information in the first storage unit 52. By providing the calibration unit 36, even if the relationship information is changed from that at delivery, the relationship information stored in the first storage unit 52 follows the change, and the generation unit 32 can generate a control signal by using the relationship information to which the change is reflected.

In a case in which an effect of the increase of the sound at the driving due to the aging is small or the like, the calibration unit 36 may be omitted as in the embodiment of FIG. 2A when the relationship information previously measured before delivery and stored in the first storage unit 52 is used. When the calibration unit 36 is omitted and the microphone 24 is a microphone other than that for recording audio data within video data at the time of video shooting, the microphone 24 may be omitted in the image-capturing apparatus 100.

A predetermined driving condition of the driving mechanism 20 includes a step width indicating a distance by which the optical element is moved depending on the target position and an update cycle of the target position. Furthermore, the driving condition of the optical element may include an environmental condition of the surroundings in which the image-capturing apparatus 100 exists. The environmental condition may include temperature, humidity, altitude or the like. The predetermined driving condition is, for example, a driving condition indicating: a distance (step width) by which a focus lens moves in one driving in a contrast autofocus (AF) for adjusting a focus position based on the contrast difference (contrast) of the image or footage while moving the focus lens; and a driving cycle (update cycle) of the focus lens.

The calibration unit 36 detects the position of the optical element based on at least one of the detection signal or the target position signal. In addition, the microphone 24 detects the sound generated due to the driving by the driving mechanism 20 and transmits the sound data to the calibration unit 36. Accordingly, the calibration unit 36 can generate sound data corresponding to the position using the sound data collected by the microphone 24 by collating the position data and the sound data.

In addition, the calibration unit 36 divides, for example, the sound data collected by the microphone 24 into sound data for each time domain based on the update cycle or step width. This specific example is described referring to FIG. 3.

FIG. 3 is an example of a graph indicating a relationship between a time and a position of an optical element, and a relationship between a time and a magnitude of sound. The calibration unit 36 divides, in accordance with the update cycle 102 of the target position indicated in the control signal or a period in which the target position indicated in the control signal is increased or decreased by step width 104, a period in which the sound data is collected by a time domain unit of the width of the update cycle according to the number of steps. In FIG. 3, an example of the period being divided into time domain A1 to A8 for illustration is indicated. The number of the time domain indicated in FIG. 3 is an illustration for description, and the number of the time domain may be smaller or may be greater in the drive control of the optical element that is actually performed by the driving mechanism 20.

In the start time point of the time domain A1 to A8, if the control signal varies by step width 104, the position of the optical element varies between each time domain A1 to A8. Accordingly, the calibration unit 36 may divide the time domain A1 to A8 based on the update cycle, or based on the timing at which the position of the optical element changes by step width 104.

Furthermore, the calibration unit 36 acquires data of the magnitude of the sound generated due to the driving by the driving mechanism 20 in each time domain. Here, in each time domain, the sound generated due to the driving by the driving mechanism 20 includes a sound depending on the magnitude of an inclination of current flowing into the voice coil motor 200 of the driving mechanism 20, and a sound that is highly dependent on the speed of the optical element.

At an end time point of each time domain, the optical element has been in a static state for a predetermined period. Accordingly, when the driving mechanism 20 drives the optical element, the static optical element is driven for a predetermined period from the start time point of each time domain having a width for each update period.

The calibration unit 36 may perform a process for generating or updating the relationship information stored in the first storage unit 52 for each step width 104 or update cycle 102 by adjusting a correction coefficient for suppressing the sound when the sound generated before and after the optical element starts the driving has a predetermined magnitude or more such that a rate of change of the current supplied to the driving mechanism 20 decreases.

Here, “before and after the optical element starts the driving” means a period from when a current for driving the optical element starts to flow in the driving mechanism 20 until when the optical element starts to be driven. That is, it means a predetermined period including a time point at which the optical element in a static state starts to be driven and a predetermined period from a time point at which each time domain starts.

In this period, in the sound generated due to friction of the optical element or the like, a friction coefficient related to friction is mainly a static friction coefficient and has less effect on the dynamic friction coefficient. In this manner, when moving the optical element from the static state, the sound is highly dependent on the magnitude of the rate of change of the current flowing into the voice coil motor 200 for moving the optical element against the static frictional force. In addition, one of the main factors of the sound in this case is a sound obtained by a coil whine phenomenon generated in response to a current flowing into an inductor of the voice coil motor 200.

When the sound generated before and after the optical element starts the driving has a predetermined magnitude or more, the calibration unit 36 decides an optimal correction coefficient which suppresses the sound by reducing the rate of change of the current supplied to the driving mechanism 20 by referring to correction coefficient information that is previously stored in the storage unit 50 and indicating the relationship between the magnitude of sound and the correction coefficient in a case where the sound generated due to the driving by the driving mechanism 20 depends on the static frictional force of the optical element.

On the other hand, after this period is elapsed, that is, “during the optical element is driven,” a ratio of the sound generated based on a dynamic frictional force or the like of the optical element is increased by the driving mechanism 20. The magnitude of the sound generated based on the dynamic frictional force or the like of the optical element is highly dependent on the speed of the optical element. With respect to a given position, the static frictional force is greater than the dynamic frictional force. However, when the movement speed is high or when an amount of grease for reducing friction at a specific position in a moving section is small or the like, a sound generated during the optical element is driven may be greater than the sound generated before and after the optical element starts the driving.

The calibration unit 36 may perform a process for generating or updating the relationship information for each step width 104 or update cycle 102 by adjusting a correction coefficient for suppressing the sound when the sound generated during the optical element is driven due to the driving mechanism 20 being driven has a predetermined magnitude or more such that a rate of change or a magnitude of the driving speed of the driving mechanism 20 is suppressed.

When the sound generated during the optical element is driven due to the driving mechanism 20 being driven has a predetermined magnitude or more, the calibration unit 36 decides an optimal correction coefficient which suppresses the sound by reducing the rate of change or the magnitude of the driving speed of the driving mechanism 20 by referring to correction coefficient information that is previously stored in the storage unit 50 and indicating the relationship between the magnitude of sound and the correction coefficient in a case where the sound generated due to the driving by the driving mechanism 20 depends on the dynamic frictional force of the optical element. The correction coefficient information is, for example, information that is obtained and stored in the storage unit 50 by: measuring the magnitude of the sound actually generated according to the position of the optical element and due to the driving while changing the correction coefficient; and deriving, by an experiment, each of the correction coefficient depending on the static frictional force of the optical element and a correction coefficient depending on the dynamic frictional force of the optical element capable of reducing the sound to be the smallest.

Furthermore, the calibration unit 36 stores the relationship information in the storage unit 50 for each case where the sound generated due to the driving by the driving mechanism 20 depends on the magnitude of the rate of change of the current and depends on the speed of the optical element. In this manner, the calibration unit 36 updates the relationship information stored in the storage unit 50.

In addition, in the sound generated due to the driving by the driving mechanism 20, when an effect of the dynamic frictional force is large, in the frequency of the sound, an effect from a frequency band equal to or less than a drive band of the driving mechanism 20 increases. In addition, fluctuation in the dynamic frictional force of the optical element may be generated, as already mentioned, by a manufacturing error in the amount of grease or the like coated on the optical element or the support feature or the like.

The sound generated by the coil whine phenomenon is a sound generated in a relatively high frequency band with respect to a driving frequency band. Accordingly, the calibration unit 36 can: analyze a frequency component of the sound generated due to the driving by the driving mechanism 20; provide a frequency threshold, for example; divide a sound of high frequency having a frequency equal to or greater than a threshold and a sound of low frequency having a frequency less than the threshold; and generate relationship information for suppressing the sound for each frequency component. As described below referring to FIG. 5, the threshold of the frequency is a threshold higher than a peak in the drive band of the driving mechanism 20 and is set as a threshold lower than a peak by the coil whine phenomenon. The threshold of the frequency may be 200 Hz, for example.

In this manner, the calibration unit 36 can generate, as a first approach for generating relationship information, the relationship information by dividing the sound generated due to the driving by the driving mechanism 20 in each time domain into a time component before and after the optical element starts the driving and a time component during the optical element is driven. The calibration unit 36 can generate, as a second approach for generating the relationship information, the relationship information by dividing the sound generated due to the driving by the driving mechanism 20 in each time domain into a frequency component equal to or greater than the threshold and a frequency component less than the threshold.

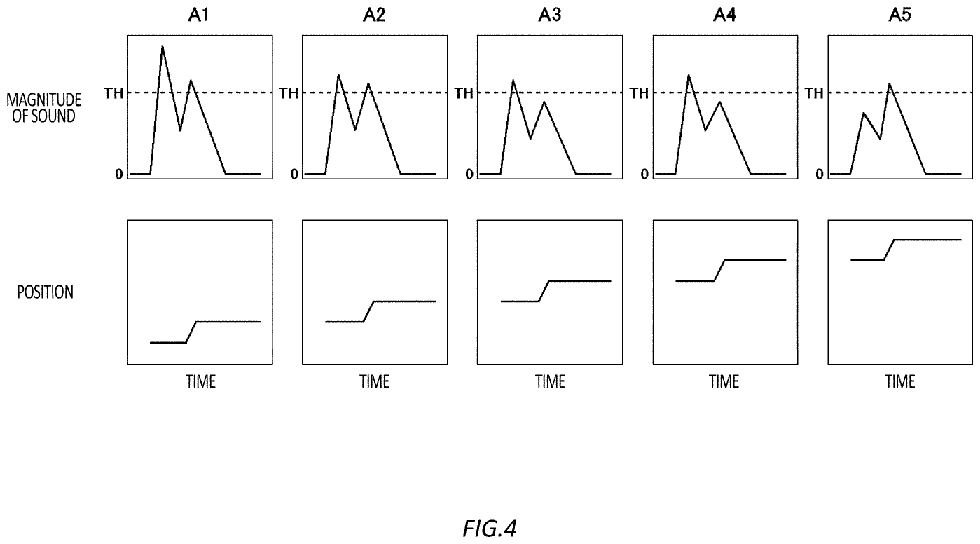

FIG. 4 shows an example of time dependence of the magnitude and the position of the sound on each time domain A1 to A5.

The calibration unit 36 controls the magnitude of the sound in each time domain A1 to A5 to be less than a threshold TH. In the sound generated due to the driving by the driving mechanism 20, a first peak in each time domain A1 to A5 is the sound generated before and after the optical element starts the driving. On the other hand, in the sound generated due to the driving by the driving mechanism 20, a peak other than the first peak in each time domain A1 to A5 is a sound generated during the optical element is driven.

In the figure, an example in which the first peak is equal to or greater than the threshold TH in the time domain A1 to A4 is indicated. On the other hand, in the example in the figure, the peaks other than the first peak are equal to or greater than the threshold TH in the time domain A1 to A2, and A5.

Accordingly, the calibration unit 36 generates the relationship information for controlling the magnitude of the rate of change of the current such that the sound generated before and after the optical element starts the driving is less than the threshold TH in the time domain A1 to A4. On the other hand, the calibration unit 36 generates the relationship information for controlling the speed of the optical element such that the sound generated during the optical element is driven is less than the threshold TH in the time domain A1 to A2, and A5.

The calibration unit 36 does not generate the relationship information for controlling the speed of the optical element in the time domain A3 and A4. In addition, the calibration unit 36 does not generate the relationship information for controlling the magnitude of the rate of change of the current and the speed of the optical element in the time domain A5.

Here, the calibration unit 36 may generate, for example, the relationship information based on the maximum value of the peak of the sound such that the sound generated due to the driving by the driving mechanism 20 is less than the threshold TH. Alternatively, the calibration unit 36 may generate the relationship information based on the area or the part enclosed between the curve depicted by the peak of the sound and the horizontal line depicted by the threshold such that the sound generated due to the driving by the driving mechanism 20 is less than the threshold TH.

The calibration unit 36 can read the position of the optical element from the magnetic sensor 22 or the target position signal. Note that, during the time domain A1 to A5, the position of the optical element varies by approximately step width 104. Accordingly, in the position information read from the magnetic sensor 22 or the target position signal, the time domain A1 to A5 and the position correspond each other with a tolerance of variation range of approximately step width 104.

FIG. 5 is a diagram exemplifying an outline of a graph indicating frequency dependence of a magnitude of the sound generated due to the driving by a driving mechanism 20.

The calibration unit 36 performs Fourier transform for converting time and frequency such as fast-Fourier transform (FFT) on the sound data of each time domain A1 to A5 collected by the magnetic sensor 22, to divide the sound in each time domain by main generation cause. That is, the calibration unit 36 extracts each of a sound equal to or greater than 200 Hz generated depending on the magnitude of the rate of change of the current and a sound less than 200 Hz depending on the speed of the optical element.

Note that, in this embodiment, the threshold is set to 200 Hz for distinguishing the main generation cause of the sound based on the experiment data in the present embodiment, but 150 Hz, 250 Hz, and 300 Hz may be used as the threshold instead of the value of 200 Hz based on a requirement of the design or the like of the image-capturing apparatus 100.

The example indicated in the figure is an outline of the peaks 112 and 114 of acquired sound data in a time domain defined based on the update cycle or step width. The peak 114 is a sound component which is higher than 200 Hz among frequency components of the sound generated due to the driving by the driving mechanism 20. The peak 114 is a peak related to a static friction coefficient of each element when the driving mechanism 20 drives the optical element. That is, the peak 114 corresponds to the first peak in the diagram indicating the magnitude of sound in FIG. 4. The peak 114 has a peak width that is easy to narrow than that of the peak 112 because the peak 114 is a peak due to the initial motion from the time in which the optical element is static.

On the other hand, the peak 112 is a sound component which is lower than 200 Hz among frequency components of the sound generated due to the driving by the driving mechanism 20. The peak 114 is a peak related to a dynamic friction coefficient of each element when the driving mechanism 20 drives the optical element. That is, the peak 114 corresponds to the peaks other than the first peak in the diagram indicating the magnitude of sound in FIG. 4. The frequency band in which the peak 114 appears is a frequency band equal to or less than the drive band of the driving mechanism 20.

Accordingly, the calibration unit 36 identifies the frequency component of the sound generated due to the driving by the driving mechanism 20 based on the sound information, and performs a process for generating or updating the relationship information for each step width 104 or update cycle 102 by adjusting the correction coefficient when a frequency component of a first frequency band is included in frequency components of a sound with magnitude of the sound of a predetermined magnitude or more such that a rate of change or a magnitude of driving speed of the driving mechanism 20 is suppressed. Here, “the first frequency” band is a band of sound generated during the optical element is driven, and a frequency band equal to or less than a drive band of the driving mechanism 20.

In addition, the calibration unit 36 performs a process for generating or updating the relationship information for each step width 104 or update cycle 102 by adjusting the correction coefficient when a frequency component of a second frequency band is included in the frequency components of the sound with the magnitude of the sound of a predetermined magnitude or more such that a rate of change of current supplied to the driving mechanism 20 decreases. Here, “the second frequency” band is a frequency band higher than the drive band of the driving mechanism 20. As mentioned above, the calibration unit 36 can generate the relationship information.

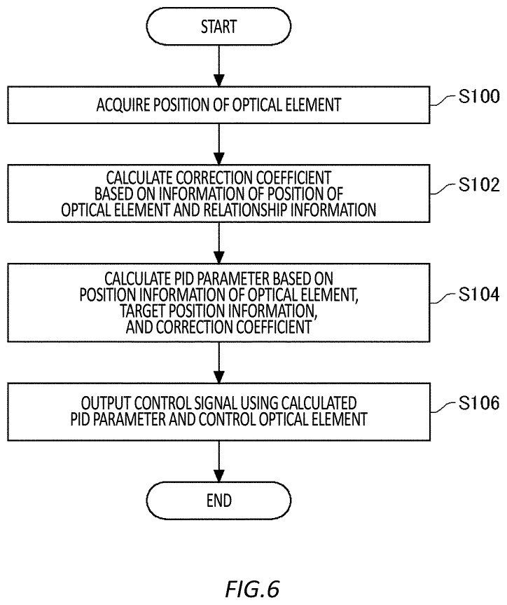

FIG. 6 is a flowchart indicating an example of a control method for controlling the driving of an optical element by using a driving mechanism control unit 30. The control method includes each step of step S100 to step S106.

The magnetic sensor 22 detects the position of the optical system 10 or the image-capturing element 12, and outputs a detection signal corresponding to the position. In addition, the image-capturing control unit 40 outputs a target position signal for moving the optical element such that the position of the optical system 10 or the image-capturing element 12 reaches the target position.

The correction coefficient output unit 322 acquires the position of the optical element based on at least one of the detection signal or the target position signal. In addition, the PID control unit 324 acquires the current position of the optical element from the detection signal (step S100).

Then, the correction coefficient output unit 322 calculates the correction coefficient based on information of the position of the optical element and relationship information stored in the first storage unit 52 (step S102), and outputs the calculated correction coefficient to the PID control unit 324. Then, the PID control unit 324 calculates the PID parameter based on position information of the optical element acquired from the detection signal, target position information acquired from the target position signal, and correction coefficient (step S104).

Then, the PID control unit 324 outputs a control signal by using the calculated PID parameter, and the driving mechanism control unit 30 controls the position of the optical system 10 or the image-capturing element 12, that is, the position of the optical element, based on the control signal (step S106). In this manner, the driving mechanism control unit 30 controls the position of the optical element.

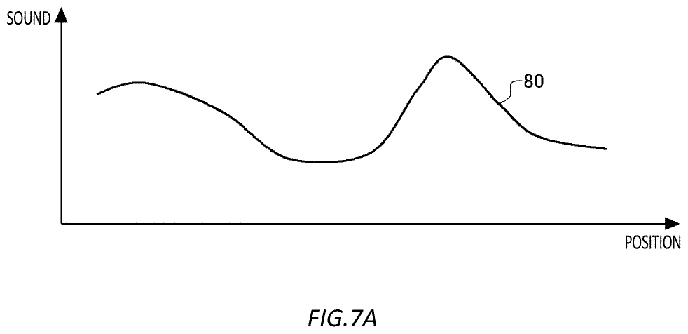

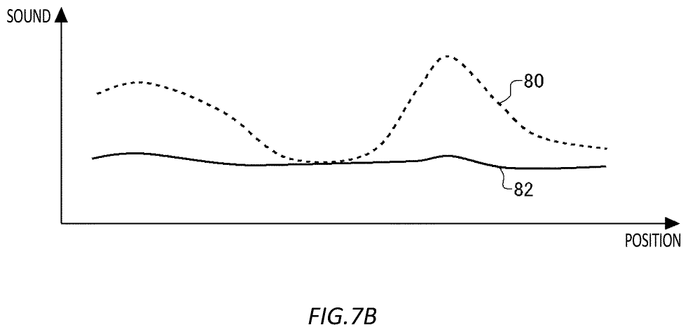

FIG. 7A is a graph indicating an example of a relationship between a position of an optical element and sound generated by the driving of the driving mechanism 20 when sound suppression control of the driving mechanism control unit 30 is not used. On the other hand, FIG. 7B is a graph indicating an example of a relationship between a position of an optical element and sound generated by the driving of the driving mechanism 20 when sound suppression control of the driving mechanism control unit 30 is used. FIG. 7A and FIG. 7B are graphs for indicating one of examples of the outline and each unit of the horizontal axis and vertical axis of these graphs is indicated as a graph of arbitrary unit (a. u.).

In FIG. 7A, the curve 80 is a curve indicating a relationship between the position of the optical element and the sound generated by the driving of the driving mechanism 20. On the other hand, in FIG. 7B, the curve 82 is a curve indicating a relationship between the position of the optical element and the sound generated by the driving of the driving mechanism 20, and the curve 80 is also indicated in a dashed line in the same figure.

In the figure, the curve 82 indicates, at all of the positions, a sound equal to or less than the sound indicated by the curve 80. Since the sound is reduced in the curve 82, the curve 82 is a curve that is substantially flat over all of the positions. As an example, in the image-capturing apparatus 100, the driving mechanism control unit 30 controls the sound generated due to the driving by the driving mechanism 20 over all of the positions of the optical element such that an absolute value of a sound at any frequency is equal to or less than a predetermined threshold.

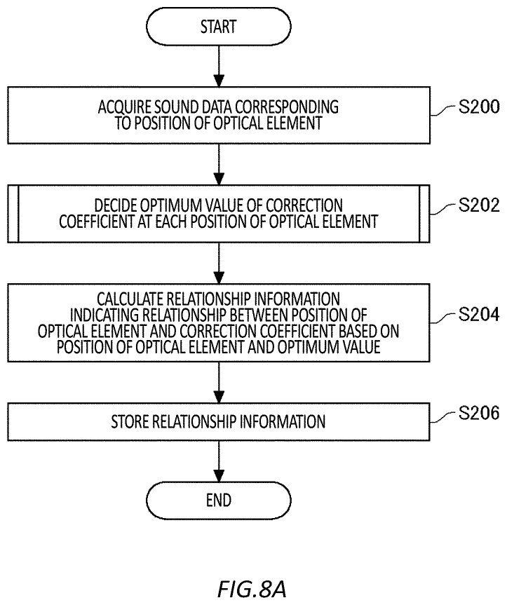

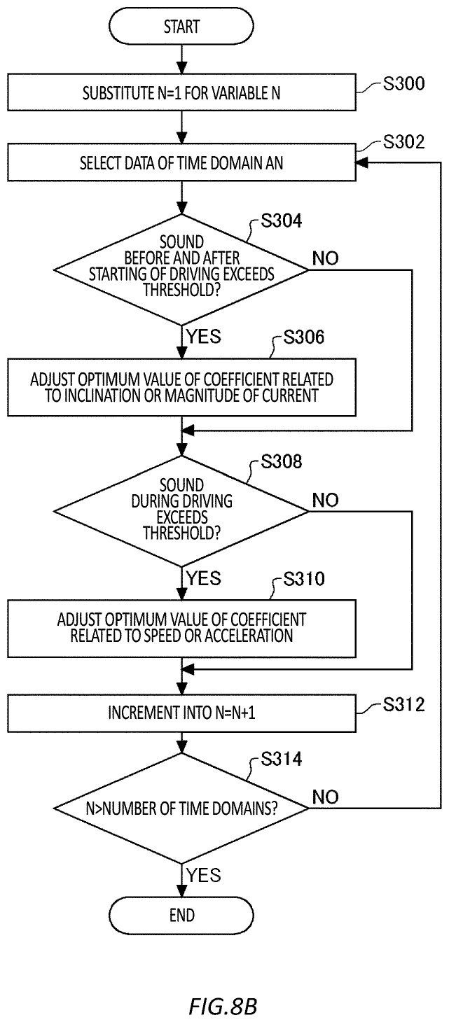

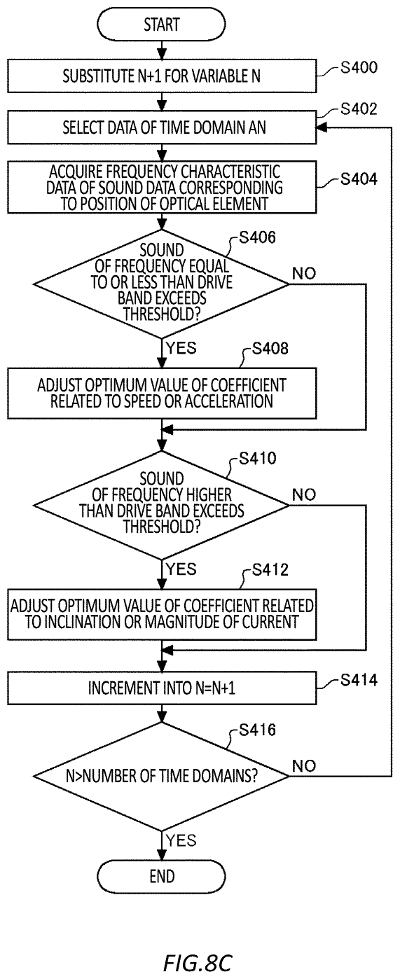

FIG. 8A is a flowchart indicating an example of an update method for updating relationship information stored in a first storage unit 52 by using a calibration unit 36. The update method includes each step of step S200 to step S206.

In this update method, a generation method for generating, by using the calibration unit 36, relationship information indicating a relationship between a correction coefficient of the control signal corresponding to the magnitude of the sound generated due to the driving by the driving mechanism 20 and the position of the optical element is indicated. Reference is made to the relationship information by the control apparatus that generates a control signal for controlling the driving mechanism 20 for moving the optical element to a target position while suppressing the sound generated due to the driving by the driving mechanism 20 that is stored in the storage unit 50 and drives the optical element. Furthermore, the first storage unit 52 is updated by the generated relationship information being stored in the first storage unit 52. In step S200 to S206 below, each step is described to be performed by the calibration unit 36.

The calibration unit 36 acquires sound data corresponding to the position of the optical element based on at least one of the detection signal or the target position signal and the position of the optical element from the sound collected by the microphone 24 (step S200).

The calibration unit 36 acquires sound data corresponding to the position of the optical element based on at least one of the detection signal or the target position signal, a driving condition of the optical element, and the position of the optical element from the sound collected by the microphone 24. The calibration unit 36 can generate sound data corresponding to the position using the sound data collected by the microphone 24 by collating the position data and the sound data.

The driving condition of the optical element may be a predetermined driving condition. Specifically, the driving condition of the optical element may include a step width 104 when the optical element is moved according to the target position. In addition, the driving condition of the optical element may include the update cycle 102 of the control signal. Furthermore, the driving condition of the optical element may include an environmental condition of the surroundings in which the image-capturing apparatus 100 exists.

Then, the calibration unit 36 decides or the calibration unit 36 and the correction coefficient output unit 322 cooperates to decide an optimum value of the correction coefficient at each position of the optical element (step S202). For example, upon receiving the sound that is collected by the microphone 24 and generated at the driving of the driving mechanism 20, the calibration unit 36 sorts a sound generated at the driving of the driving mechanism 20 from the collected sound based on a pattern or the like of a sound represented by a frequency component for each time domain corresponding to the update cycle 102 or step width 104 or a time component in a time domain.

Furthermore, the calibration unit 36 calculates relationship information indicating a relationship between the position of the optical element and the correction coefficient based on the position of the optical element and the optimum value of the correction coefficient calculated at step S202 (step S204). Then, the calibration unit 36 outputs the calculated relationship information to the first storage unit 52, and the first storage unit 52 stores updated relationship information (step S206).

For example, the calibration unit 36 acquires data that associates the magnitude of the sound generated due to the driving by the driving mechanism 20 from the first storage unit 52 and a correction coefficient to be set. By referring to this data, the calibration unit 36 decides a correction coefficient corresponding to the position of the optical system 10 or the image-capturing element 12. The calibration unit 36 may store information indicating the relationship between the position of the optical element and the correction coefficient in the first storage unit 52 as relationship information indicating a relationship between an index corresponding to the magnitude of the sound generated due to the driving by the driving mechanism 20 and the position of the optical element.

In addition, as another example, the calibration unit 36 may perform machine learning according to an algorithm of supervised learning using the sound data as an explanatory variable and using a correction coefficient that can suppress the magnitude of the sound to be equal to or less than a predetermined reference as a target variable. In this manner, the calibration unit 36 may generate a learned prediction model for predicting an optimal correction coefficient from the sound data and store it in the first storage unit 52. That is, the calibration unit 36 may predict a correction coefficient corresponding to the sound data collected by the microphone 24 for each position of the optical element based on the learned prediction model using the sound data as an explanatory variable and the correction coefficient that can suppress the magnitude of the sound to be equal to or less than a predetermined reference as a target variable. The algorithm in the machine learning may be any kind of algorithm such as a neural network, support vector machine, multiple regression analysis, decision tree or the like.

By the above update method, the calibration unit 36 can update the relationship information stored in the first storage unit 52. In this manner, by the operation of the calibration unit 36, appropriate relationship information can be updated and stored in the first storage unit 52 even if the sound generated due to the driving by the driving mechanism 20 and according to the position varies.

FIG. 8B is a flowchart describing an example of a process of step S202 in FIG. 8A. FIG. 8B indicates an example of a specific procedure about an approach for generating relationship information by dividing the sound generated due to the driving by the driving mechanism 20 in each time domain into a time component before and after the optical element starts the driving and a time component during the optical element is driven, as described by referring to FIG. 4. The procedure in the present embodiment includes each step of step S300 to step S314.

The calibration unit 36 substitutes N=1 for a variable N for a loop processing (step S300). Here, N=1 is an initial value of the variable N of an integer value.

The calibration unit 36 selects data of a time domain AN (an Nth time domain) among the acquired sound data (step S302). The calibration unit 36 determines whether the magnitude of the sound generated before and after the optical element starts the driving exceeds a threshold TH in sound data of the time domain AN (step S304).

As already described referring to FIG. 3, the magnitude of the sound generated before and after the optical element starts the driving is highly dependent on the magnitude of the rate of change of the current flowing into the voice coil motor 200. Accordingly, when the magnitude of the sound generated before and after the optical element starts the driving exceeds the threshold TH, the calibration unit 36 adjusts an inclination of the current (an absolute value of the rate of change) or an optimum value of a coefficient related to the magnitude of the current such that the magnitude of the sound does not exceed the threshold (step S306).

In step S304, when the magnitude of the sound generated before and after the optical element starts the driving is equal to or less than the threshold TH, the process proceeds to step S308. Alternatively, in step S304, when the magnitude of the sound generated before and after the optical element starts the driving exceeds the threshold TH, the magnitude of the sound is adjusted not to exceed the threshold by step S306, and then the process proceeds to step S308.

The calibration unit 36 determines whether the magnitude of the sound generated during the driving of the optical element exceeds a threshold TH in sound data of the time domain AN (step S308). As already described referring to FIG. 3, the magnitude of the sound generated during the driving of the optical element is highly dependent on the speed of the optical element. Accordingly, when the magnitude of the sound generated during the driving of the optical element exceeds the threshold TH, the calibration unit 36 adjusts the speed of the optical element or an optimum value of a coefficient related to the acceleration that is a differential value such that the magnitude of the sound does not exceed the threshold (step S308).

In step S308, when the magnitude of the sound generated during the driving of the optical element is equal to or less than the threshold TH, the process proceeds to step S312. Alternatively, in step S308, when the magnitude of the sound generated during the driving of the optical element exceeds the threshold TH, the magnitude of the sound is adjusted not to exceed the threshold by step S310, and then the process proceeds to step S312. Note that, the calibration unit 36 may perform the procedure of step S304 and step S306 after the procedure of step S308 and step S310. Alternatively, the calibration unit 36 may perform the procedure of step S304 and step S306 and the procedure of step S308 and step S310 in parallel.

The calibration unit 36 increments the variable N into N=N+1 (step S312). The calibration unit 36 determines whether a value of N after the increment exceeds the number of the time domains (step S314).

In step S314, when the value of N is equal to or less than the number of the time domains, the process is returned to step S302. On the other hand, in step S314, when the value of N exceeds the number of the time domains, the process ends.

FIG. 8C is a flowchart describing another example of a process of step S202 in FIG. 8A. FIG. 8C indicates an example of a specific procedure about an approach for generating relationship information by dividing the sound generated due to the driving by the driving mechanism 20 in each time domain into a frequency component equal to or greater than the threshold and a frequency component less than the threshold, as described by referring to FIG. 5. The procedure in the present embodiment includes each step of step S400 to step S416.

The calibration unit 36 substitutes N=1 for a variable N for a loop processing (step S300). Here, N=1 is an initial value of the variable N of an integer value.

The calibration unit 36 selects data of a time domain AN (an Nth time domain) among the acquired sound data (step S402). The calibration unit 36 performs Fourier transform (for example, fast-Fourier transform (FFT)) or the like in sound data corresponding to the position of the optical element and acquires frequency characteristic data of the sound (step S404).

The calibration unit 36 determines whether the magnitude of the sound of frequency equal to or less than a drive band of the driving mechanism 20 exceeds a threshold TH in the frequency characteristic data of the sound (step S406). As already described referring to FIG. 3, the sound of the frequency equal to or less than the drive band of the driving mechanism 20 corresponds to the sound generated during the driving of the optical element. Accordingly, when the magnitude of the sound of frequency equal to or less than a drive band of the driving mechanism 20 exceeds the threshold TH, the calibration unit 36 adjusts the speed of the optical element or an optimum value of a coefficient related to the acceleration that is a differential value such that the magnitude of the sound does not exceed the threshold (step S408).

In step S406, when the magnitude of the sound of frequency equal to or less than a drive band of the driving mechanism 20 is equal to or less than the threshold TH, the process proceeds to step S410. Alternatively, in step S406, when the magnitude of the sound of frequency equal to or less than a drive band of the driving mechanism 20 exceeds the threshold TH, the magnitude of the sound is adjusted not to exceed the threshold by step S408, and then the process proceeds to step S410.

The calibration unit 36 determines whether the magnitude of the sound of frequency higher than the drive band of the driving mechanism 20 exceeds the threshold TH in the frequency characteristic data of the sound (step S410). As already described referring to FIG. 3, the sound of the frequency higher than the drive band of the driving mechanism 20 corresponds to the sound generate before and after the optical element starts the driving. Accordingly, when the magnitude of the sound of frequency higher than the drive band of the driving mechanism 20 exceeds the threshold TH, the calibration unit 36 adjusts an inclination of the current (an absolute value of the rate of change) or an optimum value of a coefficient related to the magnitude of the current such that the magnitude of the sound does not exceed the threshold (step S412). Note that, the calibration unit 36 may perform the procedure of step S406 and step S408 after the procedure of step S410 and step S412. Alternatively, the calibration unit 36 may perform the procedure of step S406 and step S408 and the procedure of step S410 and step S412 in parallel.

In step S410, when the magnitude of the sound of frequency higher than the drive band of the driving mechanism 20 is equal to or less than the threshold TH, the process proceeds to step S414. Alternatively, in step S410, when the magnitude of the sound of frequency higher than the drive band of the driving mechanism 20 exceeds the threshold TH, the magnitude of the sound is adjusted not to exceed the threshold by step S412, and then the process proceeds to step S410.

The calibration unit 36 increments the variable N into N=N+1 (step S414). The calibration unit 36 determines whether a value of N after the increment exceeds the number of the time domains (step S416).

In step S416, when the value of N is equal to or less than the number of the time domains, the process is returned to step S402. On the other hand, in step S416, when the value of N exceeds the number of the time domains, the process ends.

As above, by any of the approaches described referring to FIG. 8B or FIG. 8C, optimal correction coefficient and relationship information can be derived even if the sound at a specific position of the optical element upon the driving of the driving mechanism 20 increases due to the aging of support features or the like of the optical element. Based on this, the driving mechanism control unit 30 can reduce the sound generated by the driving of the driving mechanism 20 without greatly reducing the driving speed of the entire drive control by the driving mechanism 20.

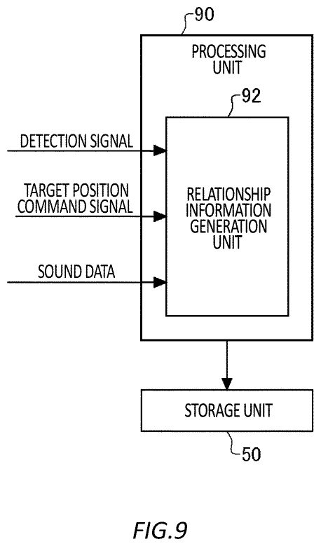

FIG. 9 is a block diagram indicating an example of a configuration of a processing unit 90 provided outside the image-capturing apparatus 100. In the figure, the processing unit 90 outside the image-capturing apparatus 100 and the storage unit 50 inside the image-capturing apparatus 100 are indicated.

The processing unit 90 is, for example, a hardware resource that is coupled to the image-capturing apparatus 100 before the factory delivery and functions as a processing apparatus that performs various information processes. The processing unit 90 is, for example, the hardware resource is, a personal computer, a workstation, a server apparatus or the like having a processor. The processing unit 90 includes a relationship information generation unit 92.

The relationship information generation unit 92 generates the relationship information based on sound information indicating a magnitude of a sound which corresponds to the position of the optical element and is generated due to the driving by the driving mechanism 20 according to a predetermined driving condition and correction coefficient information indicating a relationship between the magnitude of the sound and the correction coefficient. That is, the relationship information generation unit 92 may perform a function similar to that of the calibration unit 36 in FIG. 2B for updating the relationship information, but is a component outside the image-capturing apparatus 100 that may be provided with the magnetic sensor 22, the driving mechanism control unit 30 or the like.

As already mentioned, the driving mechanism control unit 30 functions as a control apparatus that generates a control signal for controlling the driving mechanism for moving the optical element to the target position while suppressing the sound generated due to the driving by the driving mechanism 20 that drives the optical element. Accordingly, the processing unit 90 includes the relationship information generation unit 92 that generates relationship information, so as to function as a generation apparatus of relationship information that generates relationship information being referred by the control apparatus and indicating a relationship between the correction coefficient of the control signal corresponding to the magnitude of the sound generated due to the driving by the driving mechanism 20 and the position of the optical element.

The storage unit 50 is a storage unit similar to those described referring to FIG. 1, FIG. 2A, and FIG. 2B. The storage unit 50 stores the relationship information generated by the relationship information generation unit 92.

When the processing unit 90 is not provided in the image-capturing apparatus 100, updating of the relationship information may be required due to the aging of the support portion of the optical element, the driving mechanism 20, or the like. In such a case, for example, the processing unit 90 may be an information processing apparatus provided in a repair shop, a customer support center or the like, or may be an information processing apparatus that can communicate with the image-capturing apparatus 100 in a wired or wireless manner.

For example, when the processing unit 90 is provided in the information processing apparatus that is capable of wireless communication, the storage unit 50 stores sound data corresponding to the position collected by the microphone; and the magnitude of the sound for each frequency component included in the sound data or the magnitudes of the sound generated before and after the optical element starts the driving and the sound generated during the optical element is driven. The image-capturing apparatus 100 transmits such data to the processing unit 90 provided outside, and receives the relationship information from the processing unit 90. Then, the storage unit 50 stores the relationship information that is received.

As mentioned above, the processing unit 90 provided outside the image-capturing apparatus 100 can also update the relationship information.

While the present invention has been described by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

It should be noted that the operations, procedures, steps, stages, etc. of each process performed by an apparatus, system, program, and method shown in the claims, specification, or diagrams can be performed in any order as long as the order is not indicated by “prior to,” “before,” or the like and as long as the output from a previous process is not used in a later process. Even if the operational flow is described by using phrases such as “first” or “next” in the claims, specification, or diagrams, it does not necessarily mean that the process must be performed in this order.

### EXPLANATION OF REFERENCES

10 optical system
12 image-capturing element
20 driving mechanism
22 magnetic sensor
24 microphone
30 driving mechanism control unit
32 generation unit
40 image-capturing control unit
50 storage unit
52 first storage unit
54 second storage unit
60 display unit
70 operation unit
80, 82 curve
90 processing unit
92 relationship information generation unit
100 image-capturing apparatus
102 update cycle
104 step width
36 calibration unit
112, 114 peak
200 voice coil motor
202 motor driver
322 correction coefficient output unit
324 PID control unit.

What is claimed is:

1. An IC chip that controls a driving mechanism that drives an optical element based on a control signal, comprising:
a generation unit that generates the control signal for moving the optical element to a target position while suppressing a sound generated due to a driving by the driving mechanism, based on a detection signal indicating a position of the optical element and relationship information indicating a relationship between an index corresponding to a magnitude of the sound generated due to the driving by the driving mechanism and a position of the optical element.

2. The IC chip according to claim 1, wherein the generation unit generates, in order to suppress the sound generated due to the driving by the driving mechanism by suppressing moving speed or moving acceleration of the optical element, the control signal corresponding to the position of the optical element based on the relationship information.

3. The IC chip according to claim 1, wherein the generation unit generates, in order to suppress the sound generated due to the driving by the driving mechanism by suppressing at least one of a magnitude of a rate of change of current or a magnitude of current supplied to the driving mechanism, the control signal corresponding to the position of the optical element based on the relationship information.

4. The IC chip according to claim 1, wherein
the relationship information indicates a correction coefficient for correcting the control signal according to the magnitude of the sound generated due to the driving by the driving mechanism as the index;
the generation unit identifies the position of the optical element based on at least one of a target position signal indicating the detection signal or the target position, identifies, by referring to the relationship information, the correction coefficient corresponding to the position of the optical element that has been identified, and generates the control signal based on the correction coefficient corresponding to the position of the optical element, the target position signal, and the detection signal.

5. The IC chip according to claim 4, wherein the generation unit generates, based on the correction coefficient corresponding to the position of the optical element, the target position signal, and the detection signal, the control signal for performing a PID control on the driving mechanism by performing four arithmetic operations using the correction coefficient corresponding to the position of the optical element on at least one of a proportional component, a differential component, or an integral component based on a deviation between the target position signal and the detection signal.

6. The IC chip according to claim 5, wherein
the generation unit generates the control signal for correcting a gain of a drive band of the driving mechanism by performing the four arithmetic operations using the correction coefficient corresponding to the position of the optical element; and
the drive band indicates equal to or less than 200 Hz.

7. The IC chip according to claim 1, further comprising a storage unit for storing the relationship information.

8. The IC chip according to claim 2, wherein
the relationship information indicates a correction coefficient for correcting the control signal according to the magnitude of the sound generated due to the driving by the driving mechanism as the index;
the generation unit identifies the position of the optical element based on at least one of a target position signal indicating the detection signal or the target position, identifies, by referring to the relationship information, the correction coefficient corresponding to the position of the optical element that has been identified, and generates the control signal based on the correction coefficient, the target position signal, and the detection signal.

9. The IC chip according to claim 3, wherein
the relationship information indicates a correction coefficient for correcting the control signal according to the magnitude of the sound generated due to the driving by the driving mechanism as the index;
the generation unit identifies the position of the optical element based on a target position signal indicating at least one of the detection signal or the target position, identifies, by referring to the relationship information, the correction coefficient corresponding to the position of the optical element that has been identified, and generates the control signal based on the correction coefficient, the target position signal, and the detection signal.

10. The IC chip according to claim 1, wherein
the IC chip is operable under a correction mode in which the control signal is corrected based on the relationship information and a non-correction mode in which the control signal is not corrected based on the relationship information; and
the generation unit generates the control signal for moving the optical element to the target position while suppressing the sound generated due to the driving by the driving mechanism based on the detection signal and the relationship information during an operation of the IC chip under the correction mode.

11. The IC chip according to claim 10, further comprising a magnetic sensor that outputs the detection signal; wherein
the magnetic sensor has a plurality of hall elements.

12. The IC chip according to claim 1, wherein
the relationship information indicates a correction coefficient for correcting the control signal according to the magnitude of the sound generated due to the driving by the driving mechanism as the index;
the generation unit generates the control signal based on the correction coefficient corresponding to the position of the optical element, a target position signal indicating the target position, and the detection signal; and wherein the IC chip further comprises:
a calibration unit that generates or updates the relationship information based on sound information indicating a magnitude of a sound which corresponds to the position of the optical element and is generated due to the driving by the driving mechanism according to a predetermined driving condition and correction coefficient information indicating a relationship between a magnitude of sound and a correction coefficient.

13. The IC chip according to claim 12, wherein
the predetermined driving condition includes a step width indicating a distance by which the optical element is moved depending on the target position and an update cycle of the target position.

14. The IC chip according to claim 13, wherein the calibration unit:
performs a process for generating or updating the relationship information for every step width being the step width or every update cycle being the update cycle by adjusting a correction coefficient for suppressing a sound when the sound generated before and after the optical element starts being driven has a predetermined magnitude or more such that a rate of change of current supplied to the driving mechanism decreases; and
performs a process for generating or updating the relationship information for every step width being the step width or every update cycle being the update cycle by adjusting a correction coefficient for suppressing a sound when the sound generated during the optical element is driven due to the driving mechanism being driven has a predetermined magnitude or more such that a rate of change or a magnitude of driving speed of the driving mechanism is suppressed.

15. The IC chip according to claim 13, wherein the calibration unit:
identifies a frequency component of the sound generated due to the driving by the driving mechanism based on the sound information;
performs a process for generating or updating the relationship information for every step width being the step width or every update cycle being the update cycle by adjusting the correction coefficient when a frequency component of a first frequency band is included in frequency components of a sound with a magnitude of the sound of a predetermined magnitude or more such that a rate of change or a magnitude of driving speed of the driving mechanism is suppressed; and
performs a process for generating or updating the relationship information for every step width being the step width or every update cycle being the update cycle by adjusting the correction coefficient when a frequency component of a second frequency band that is higher than the first frequency band is included in the frequency components of the sound with the magnitude of the sound of a predetermined magnitude or more such that a rate of change of current supplied to the driving mechanism decreases; and wherein
the first frequency band is equal to or less than a drive band of the driving mechanism, and the second frequency band is higher than the drive band of the driving mechanism.

16. A control method for controlling a driving mechanism that drives an optical element based on a control signal, comprising:
generating the control signal for moving the optical element to a target position while suppressing a sound generated due to the driving by the driving mechanism, based on a detection signal indicating a position of the optical element and relationship information indicating a relationship between an index corresponding to a magnitude of the sound generated due to the driving by the driving mechanism and a position of the optical element.

17. A generation method that generates relationship information indicating a relationship between a correction coefficient of a control signal corresponding to a magnitude of a sound generated due to the driving by a driving mechanism and a position of an optical element, the relationship information being referred by a control apparatus that generates the control signal for controlling the driving mechanism for moving the optical element to a target position while suppressing the sound generated due to the driving by the driving mechanism that drives the optical element, wherein the method comprises:
generating the relationship information based on sound information indicating a magnitude of a sound which corresponds to the position of the optical element and is generated due to the driving by the driving mechanism according to a predetermined driving condition and correction coefficient information indicating a relationship between the magnitude of the sound and the correction coefficient.

18. The generation method according to claim 17, wherein
the predetermined driving condition includes a step width indicating a distance by which the optical element is moved depending on the target position and an update cycle of the target position.

19. The generation method according to claim 18, wherein the generating includes:
performing a process for generating the relationship information for every step width being the step width or every update cycle being the update cycle by adjusting a correction coefficient for suppressing a sound when the sound generated before and after the optical element starts being driven has a predetermined magnitude or more such that a rate of change of current supplied to the driving mechanism decreases; and
performing a process for generating the relationship information for every step width being the step width or every update cycle being the update cycle by adjusting a correction coefficient for suppressing a sound when the sound generated during the optical element is driven due to the driving mechanism being driven has a predetermined magnitude or more such that a rate of change or a magnitude of driving speed of the driving mechanism is suppressed.

20. The generation method according to claim 18, wherein the generating includes:
identifying a frequency component of the sound generated due to the driving by the driving mechanism based on the sound information;
performing a process for generating the relationship information for every step width being the step width or every update cycle being the update cycle by adjusting the correction coefficient when a frequency component of a first frequency band is included in frequency components of a sound with a magnitude of the sound of a predetermined magnitude or more such that a rate of change or a magnitude of driving speed of the driving mechanism is suppressed; and
performing a process for generating the relationship information for every step width being the step width or every update cycle being the update cycle by adjusting the correction coefficient when a frequency component of a second frequency band that is higher than the first frequency band is included in the frequency components of the sound with the magnitude of the sound of a predetermined magnitude or more such that a rate of change of current supplied to the driving mechanism decreases; and wherein
the first frequency band is equal to or less than a drive band of the driving mechanism, and the second frequency band is higher than the drive band of the driving mechanism.
